(19) United States
(12) Patent Application Publication
(10) Pub. No.: US 2006/0275068 A1
(43) Pub. Date: Dec. 7, 2006

(54) Printing device and method for printing on a surface

(75) Inventor: Alex Breton, Enskede Gard (SE)

Correspondence Address: DICKSTEIN SHAPIRO LLP, 1825 EYE STREET NW, Washington, DC, 20006-5403, US

(73) Assignee: PRINT DREAMS EUROPE AB, Kista (SE)

(21) Appl. No.: 10/558,066

(22) PCT Filed: May 23, 2003
(86) PCT No.: PCT/SE03/00843

§ 371 Date: Jul. 26, 2006

(51) Int. Cl. B41J 19/30

(52) U.S. Cl. 400/323

(57) ABSTRACT

The present invention relates to a printing device (10; 40) for printing on a surface comprising: a print head (12; 41) including an ink reservoir (20), a housing (11) that is pressed against a printout surface (17). The print head (12) is movable along and guided by one or more steering beams (30) in the housing (11) and ejecting ink drops on the printout surface (17). The device further include means to determine parameters of movement of the print head (12) using at least one sensor (16) for determining the parameters of movement of the print head (12) in relation to the printout surface (17), and means (21) for controlling a stream of ink drops against said printout surface (17) according to a predetermined pattern, in accordance with the determined parameters. The invention also relates to a method for printing on a surface.

### TECHNICAL FIELD

The present invention relates to a printing device as defined in the preamble of claim 1. The invention also relates to a method for effectuating a printout as defined in the preamble of claim 8.

### BACKGROUND TO THE INVENTION

Small handheld printing devices have been disclosed in the prior art for printing an image on a surface. In the international patent application PCT/SE01/01575, with publication number WO 02/02343, by the present applicant, an electronic stamp is disclosed where a vertical movement is transformed into a horizontal movement of a print head. A control unit controls the printing of the selected image, which may be stored in a memory. Phototransistors sense the position of the print head using beams with openings, which position information is transferred to the control unit to aid in the printing process of the image. A drawback with this design is that printing device is rather bulky and the printing process requires a person to perform a vertical movement that could lead to injuries. It is also very difficult to see the printed image during the printing process, since the housing of electronic stamp is placed on top of the printout surface.

In EP 0 564 297 a printing device is disclosed having a printing mechanism where two stepping motors are attached to the movable print head. The control unit controls the movement of the print head using the stepping motors and dependent on the position of the print head, ink drops are ejected to form an image on a printout surface. The printed image may also be seen without removing the housing of the printing device. The drawback with this design is that power to control the stepping motors needs to be provided, which could be difficult if the printing device is going to be portable. A power cord has to be provided unless batteries are provided inside the printing device.

In an international patent application PCT/SE01/01307, with the publication number WO 01/94118, by the present applicant, a hand held printer is disclosed having two sensors, operating in the plane of a printout surface, for determining the position of the print head. The position information is fed back to the control unit, which effectuates the printing of an image using a random movement printing technology (RMPT). A drawback with the hand held printer is that it is complex and thereby rather expensive to manufacture. Furthermore, it is difficult to see the result of the printing process until the printer is either lifted off the printout surface or moved to the side.

There is a need for a printing device that is easy to manufacture at affordable prices, and that is easy to use when printing small images, such as stamps.

### SUMMARY OF THE INVENTION

The object of the present invention is to provide a printing device, and a method, for printing an image onto a printout surface where at least a part of the image may be seen without removing the printing device using low power consumption compared to prior art printing devices.

This object is achieved by a printing device as defined in the characterising portion of claim 1, and a method for printing an image on a printout surface as defined by the characterising portion of claim 8.

An advantage with the present invention is that the printing device is less expensive to manufacture compared to prior art printing devices.

Another advantage is that the printing device is easier to use, compared to prior art, which in turn will lead to a reduction of working related injuries.

Further objects and advantages of the present invention will be apparent to those skilled in the art from the following detailed description of the disclosed printing device and the printing process steps.

### BRIEF DESCRIPTION OF THE DRAWINGS

The different embodiments shown in the appended drawings are not to scale or proportion, but exaggerated to point out different important features for the sake of clarity.

FIG. 1 shows a view from below of a first embodiment of a printer according to the invention.

FIG. 2 shows a cross-sectional side view of the printer in FIG. 1 along A-A.

FIG. 3 shows a schematic overview of the printer.

FIG. 4 shows a cross-sectional top view of the printer in FIG. 1.

FIG. 5 shows cross-sectional side view of the printer in FIG. 5 along B-B.

FIG. 6 shows a view from below of a second embodiment of a printer according to the invention.

### DETAILED DESCRIPTION OF PREFERRED EMBODIMENTS

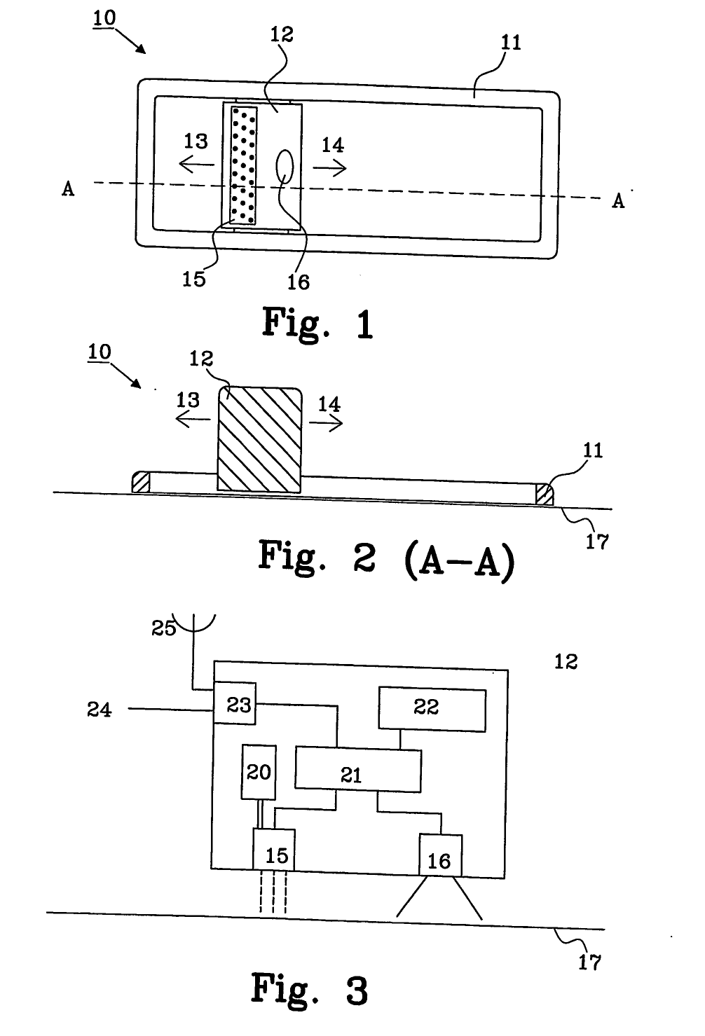

FIG. 1 shows a view from below of a first embodiment of a printer 10 according to the invention. The printer comprises two parts, a housing 11 and a print head 12 including an ink reservoir (not shown). The print head 12 is movable in relation to the housing 11, as indicated by the arrows 13 and 14. The print head 12 also include several ink nozzles 15 for ejecting ink drops onto a printout surface. The number and the position of the nozzles 15 are dependent on the resolution and the size of the printed image.

A sensor 16 for determining the position and the relative movement of the print head 12 in relation to the printout surface is also provided. For practical reasons, the sensor is positioned on the print head, since the housing 11 is pressed to the printout surface and only the print head 12 is moving. The movement of the print head is preferably executed by hand.

The sensor, e.g. a component available from Agilent Technologies (product name HDNS-2000), is connected to a micro controller circuit (not shown) to determine the position of the print head 12, the speed, acceleration and direction and/or other parameters. The micro controller circuit is arranged within the print head 12.

FIG. 2 shows a cross-sectional view of the first embodiment 10 along A-A in FIG. 1. A printout surface 17 is shown upon which the printer 10 is arranged. The print head 12 is positioned en distance from the printout surface 17 when the housing 11 is pressed against the surface 17.

The print head 12 is guided along at least one steering beam (not shown) to ensure a movement in one direction only and to ensure a uniform distance to the printout surface during movement of the print head 12.

FIG. 3 shows a schematic overview of the printer 10 comprising nozzles 15, a sensor 16, an ink reservoir 20, a micro controller circuit 21, an optional memory 22, and an input/output (I/O) interface 23. The I/O interface 23 could be connected to a computer (not shown) by means of wire 24 and/or a radio communication link 25. Images that should be printed on the printout surface 17 by the printer 20 are transferred from the computer to the micro controller circuit 21. Optionally the images are stored in the memory 22 and the I/O interface 23 could be used to add, delete and/or edit images stored in the memory 22.

The micro controller circuit 21 collects data from the sensor 16, compare the actual position of the print head with the image to be printed and thereafter controls the nozzles 15 to eject ink drops at the appropriate position.

The print head 12 could also be provided with a reset button (not shown) which must be activated before the printing of the image could commence. The reset button could be placed in such a way that it automatically is activated when the print head 12 is moved to a starting position, e.g. adjacent to the housing 11 when the print head 12 is in the left or right end position. The reset button will ensure that the printing is not started with the print head 12 in the wrong position.

The print head may also be biased into a starting position using springs to move the print head 12 into the starting position when not purposely moved. The printing device may also be provided with a manually actuated print button arranged on the housing 11 or the print head, which must be activated before the printing may commence.

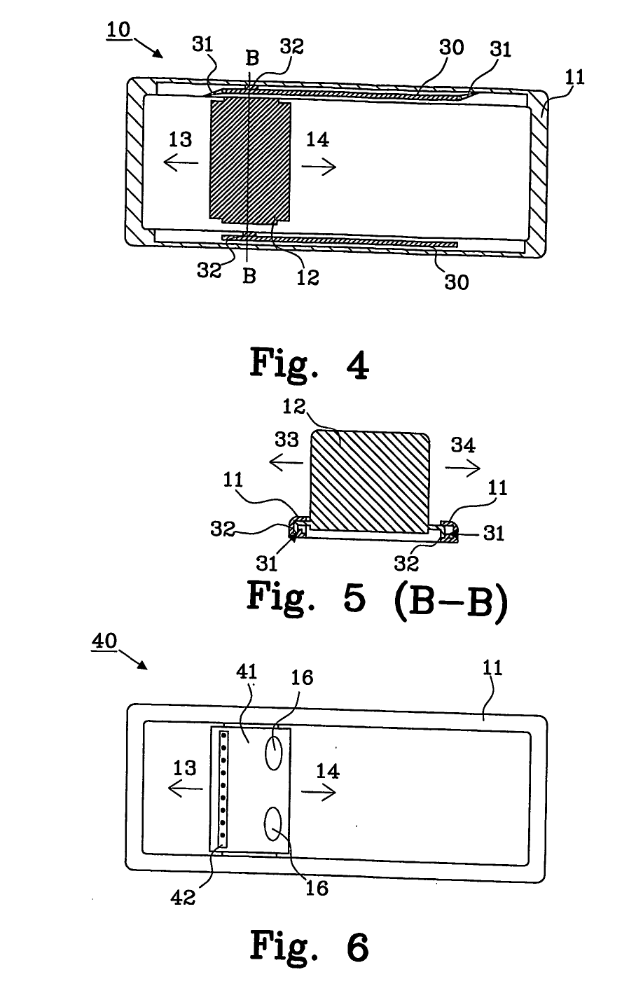

FIG. 4 shows a cross-sectional top view of the printer 10 in FIG. 1, and FIG. 5 is a cross-sectional view along B-B of the printer 10 in FIG. 4. The print head 12 is movably arranged inside the housing 11 in the directions 13 and 14. Furthermore, the print head 12 is arranged to travel along a first path when moved in a first direction 13, and along a second path when moved in a second direction 14 opposite to the first direction 13.

The print head 12 is shifted between the first and the second path at the respective end position of the print head 12. Steering beams 30 arranged inside the housing 11 separates the first and the second path and guides the print head 12 along the paths. A lever 31, preferably biased to prevent the print head to enter the incorrect path when moved, is provided at each end position in connection with at least one of the steering beams 30. The print head 12 is guided along respective path by a guide 32, which is attached to the print head, as is clearly shown in FIG. 5. Arrows 33 and 34 indicate the movement of the print head 12 when the guide 32 shifts from the first to the second path.

FIG. 6 is a second embodiment of a printer device 40 according to the invention. A housing 11 is provided with a print head 41, which is movable within the housing 11, as discussed in the first embodiment above. The print head is provided with a less expensive type of nozzles 42 and two sensors 16 to detect the movement and position of the print head. Two sensors 16 will further ensure a correct calculation of the parameters of movement.

The printing device 10, 40 may be used as a postage meter device, where the printing device is loaded with a certain amount of cash, through the I/O interface 23, which amount is stored in the memory 22, to facilitate printing of stamps on envelopes, packages, etc. In this case the micro controller circuit 21 is also provided with means to calculate the remaining amount of cash available for the printer device to print.

A major advantage with the present invention is that the surface area where the image is intended to be print, van be observed during the whole printing process, except when the print head 12 passes the intended area. Therefore, it is easy to place and print the image in the correct place. The image could of course include any type of picture, text, etc.

1. A printing device (10; 40) for printing on a surface comprising:
a print head (12; 41) including an ink reservoir (20),
a housing (11) that is pressed against a printout surface (17), wherein said print head (12) is movable along and guided by one or more steering beams (30) in said housing (11) and ejecting ink drops on the printout surface (17),
means to determine parameters of movement of the print head (12), and
means (21) for controlling a stream of ink drops against said printout surface according to a predetermined pattern, in accordance with the determined parameters,
characterised in that said printing device further comprises:
at least one sensor (16) for determining the parameters of movement of the print head (12) in relation to the printout surface (17).

2. The printing device according to claim 1, wherein the sensor (16) is mounted on, or integrally arranged in, said print head (12), facing the printout surface (17).

3. The printing device according to claim 1, wherein the printing device is provided with means to manually move the print head (12) along the steering beam.

4. The printing device according to claim 1, wherein the printing device is provided with means (31,32) to allow the print head (12) to move along different paths dependent on the direction of movement (13,14).

5. The printing device according to claim 1, wherein the parameters of movement of the print head (12,41) comprises one or more of: the position, the direction of movement, the speed and the acceleration.

6. The printing device according to claim 1, wherein means to establish a starting position is provided before the ink drops are ejected.

7. The printing device according to claim 6, wherein the means to determine the starting position is a button arranged on said print head (12).

8. A method for printing on a surface (17) using a printing device (10; 40) having a print head (12; 41) including an ink reservoir (20), a housing (11) wherein said print head (12; 41) is movable along and guided by one or more steering beams (30) in said housing (11), wherein the method comprises the steps of:
pressing the housing (11) of the printing device on a printout surface (17),
moving the print head (12; 41) along the steering beam(s) (30) in a first direction (13) and ejecting ink drops on the printout surface (17),
determining parameters of movement of the print head (12; 41),
controlling a stream of ink drops against said printout surface (17) according to a predetermined pattern, in accordance to the determined parameters,
characterised in that the method further comprises the step:
providing at least one sensor (16) for determining the parameters of movement of the print head (12; 41) in relation to the printout surface (17).

9. The method according to claim 8, wherein the following step is performed before the ejecting the ink drops:
actuating a means to establish a starting position for the printing on the printout surface.

10. The method according to claim 8, wherein said printing device is provided with means (31,32) to allow the print head (12) to move along different paths dependent on the direction of movement (13,14) and the method comprises the step of shifting position of the print head (12) when changing the direction of movement (13,14).
